(19) United States
(12) Patent Application Publication
(10) Pub. No.: US 2005/0066372 A1
(43) Pub. Date: Mar. 24, 2005

(54) Method for reception by a terminal of contents broadcast by a plurality of channels through a computer network

(76) Inventor: Christian Bertin, Rennes (FR)

Correspondence Address: COHEN, PONTANI, LIEBERMAN & PAVANE, 551 FIFTH AVENUE, SUITE 1210, NEW YORK, NY, 10176, US

(21) Appl. No.: 10/489,148

(22) PCT Filed: Sep. 5, 2002
(86) PCT No.: PCT/FR02/03026

(30) Foreign Application Priority Data
Sep. 18, 2001 (FR) 01/12070

(51) Int. Cl. H04N 7/173

(52) U.S. Cl. 725/114

(57) ABSTRACT

A method of reception by a terminal (T) of contents broadcast over a computer network via two or more broadcast channels (CD0, CD1), and a terminal for implementing the method. A signaling channel (CS0) is associated with the first broadcast channel (CD0) and the terminal (T) acquires said signaling channel (CS0) and switches from the first broadcast channel (CD0) to the second broadcast channel (CD1) via said signaling channel (CS0).

The present invention relates to a method of reception by a terminal of content broadcast by a plurality of channels via a computer network.

Many television stations broadcast their programs from a broadcast source via a hierarchy of local relay transmitters covering a given geographical area. Each relay transmitter receives an audiovisual signal conveying the program being broadcast and transmits it to other relay transmitters in order to route it from the source to the receivers. A relay transmitter can temporarily interrupt the received program and transmit a different program instead. This is referred to as “handover” and is used by some national stations, which generally have only one broadcast channel, to broadcast regional programs between two national programs. During “handover” periods, receivers in a given region can receive only the program for that region, to the exclusion of other regional programs.

Some television stations also broadcast programs, more usually referred to in this case as “content”, over the Internet, generally using a “multicast” broadcasting method which consists in a source S sending IP data packets conveying the content to be broadcast via the Internet in a single sending. The IP packets are then duplicated by “routers”, i.e. nodes of the network, and routed via the Internet to the receiver terminals. To receive a content, each receiver terminal must first recover a session description protocol (SDP) file associated with the source S, for example by downloading it from a website. The structure of an SDP file is defined by the Internet Engineering Task Force (IETF) in the document RFC 2327. The file conveys information required for receiver terminals to receive multimedia content broadcast by the source S. For each source S there is a general SDP file containing all the information required to receive from the source S, regardless of the content it is broadcasting. For each broadcast content (TV transmission, film, conference, etc.) there is also a specific SDP file containing all the information needed to receive that particular content. The general SDP file of the source S is valid regardless of the content that the source is broadcasting, whereas the SDP file of a specific content is valid only for the broadcasting of that content. If a terminal wishes to receive a multimedia content broadcast by the source S, it sends a request to acquire that content to the source S via the Internet using the Internet Group Management Protocol (IGMP). The first router that receives the request and is already receiving the IP packets broadcast by the source S duplicates the IP packets and then routes them to the terminal or to another router nearer the terminal. Because the content is sent by the source S in one sending, the multicast technique is not greedy in terms of bandwidth. The same station could therefore broadcast different contents simultaneously over different broadcast channels without unacceptably increasing its bandwidth consumption. However, to receive the various channels, the receiver terminals would have to recover as many SDP files as there are channels that can be received and establish the link between the channels for themselves.

The technical problem addressed by the present invention is therefore that of proposing a method of reception by a terminal of two or more broadcast channels that provides a simple way for the terminal to change channel.

To this end, the invention consists in a method of reception, by a terminal, of content broadcast over a computer network by a plurality of broadcast channels forming a group of channels linked in accordance with a given organization, in which method:
each broadcast channel is associated with a signaling channel conveying information for acquiring said broadcast channel,
the terminal acquires a first signaling channel associated with a first broadcast channel and, from said first signaling channel, starts to receive the first broadcast channel, and
to switch from the first broadcast channel to a second broadcast channel linked to the first broadcast channel, the terminal acquires a second signaling channel associated with a second broadcast channel from the first signaling channel and, from the second signaling channel, starts to receive the second broadcast channel.

The signaling channel associated with the broadcast channel carries all the information needed for the terminal to acquire the broadcast channel. Accordingly, to switch to a given broadcast channel, the terminal first acquires the associated signaling channel. In the prior art, the broadcast channels were independent of each other and used exclusively to carry broadcast content. The invention therefore consists in linking the broadcast channels by way of a signaling channel to enable the terminal to switch from one broadcast channel to another.

To switch from the second broadcast channel to the first broadcast channel, the terminal advantageously acquires the signaling channel associated with the first broadcast channel from the signaling channel associated with the second broadcast channel. Accordingly, after switching from the first broadcast channel to the second broadcast channel, the terminal can return to the first broadcast channel via the signaling channel associated with the second broadcast channel.

The signal channel associated with one of the broadcast channels preferably indicates to the terminal whether the two broadcast channels are broadcasting simultaneously or alternately. When the terminal is receiving a given broadcast channel, thanks to the associated signaling channel, it can tell whether it can change channel during the broadcasting of content via the current channel or must wait for the end of the current broadcast.

The signaling channel associated with one of the broadcast channels advantageously supplies the terminal with a computer address of the signaling channel associated with the other broadcast channel. The terminal can use this address to cover the corresponding signaling channel.

The signaling channel associated with one of the broadcast channels can supply the terminal with an indication of the starting of broadcasting via the other broadcast channel and/or an indication of the stopping of broadcasting via the other broadcast channel. Accordingly, when the terminal is receiving one of the two broadcast channels, it does not need to change broadcast channel to find out if the other channel is broadcasting a content. That information is supplied to it directly by the signaling channel associated with the broadcast channel it is receiving. Furthermore, using the end-of-broadcast indication, the terminal can automatically change broadcast channel at the end of a broadcast without intervention by its user.

During reception of the content broadcast by one of the broadcast channels, the terminal advantageously informs a user of parallel broadcasting over the other broadcast channel, and changes broadcast channel in response to a switching command from said user. For example, while the terminal is receiving one broadcast channel, it can display an icon indicating that a broadcast is taking place on the other broadcast channel. To change broadcast channel it suffices to select the icon.

With contents being broadcast over a plurality of broadcast channels respectively associated with a plurality of signaling channels and forming a group of channels, each signaling channel advantageously supplies the terminal with the information for acquiring one or more other signaling channels associated with another broadcast channel of the same group so that the terminal can access all the broadcast channels of the group.

In one particular embodiment, the group of channels comprises a main channel and a plurality of secondary channels, and the signaling channel associated with the main channel supplies the terminal with the information to acquire signaling channels associated with all the secondary channels.

The signaling channel associated with each secondary channel advantageously supplies the terminal with information for acquiring the signaling channel associated with the main channel, to the exclusion of information for the signaling channels associated with the other secondary channels.

In this embodiment of the invention, the terminal can switch from the main channel to any secondary channel. However, it must switch from one secondary channel to another secondary channel via the main channel. This prevents overloading the signaling channels associated with the secondary channels with information, and consequently limits the consumption of bandwidth, and facilitates updating the signaling channels.

The invention also consists in a terminal for implementing the method defined above, comprising means for acquiring a signaling channel associated with a broadcast channel and means for switching from said broadcast channel to another broadcast channel with the aid of said signaling channel.

The invention will be better understood in the light of the following description of an implementation of a reception method and a terminal in accordance with the invention, which description is given with reference to the accompanying drawings, in which:

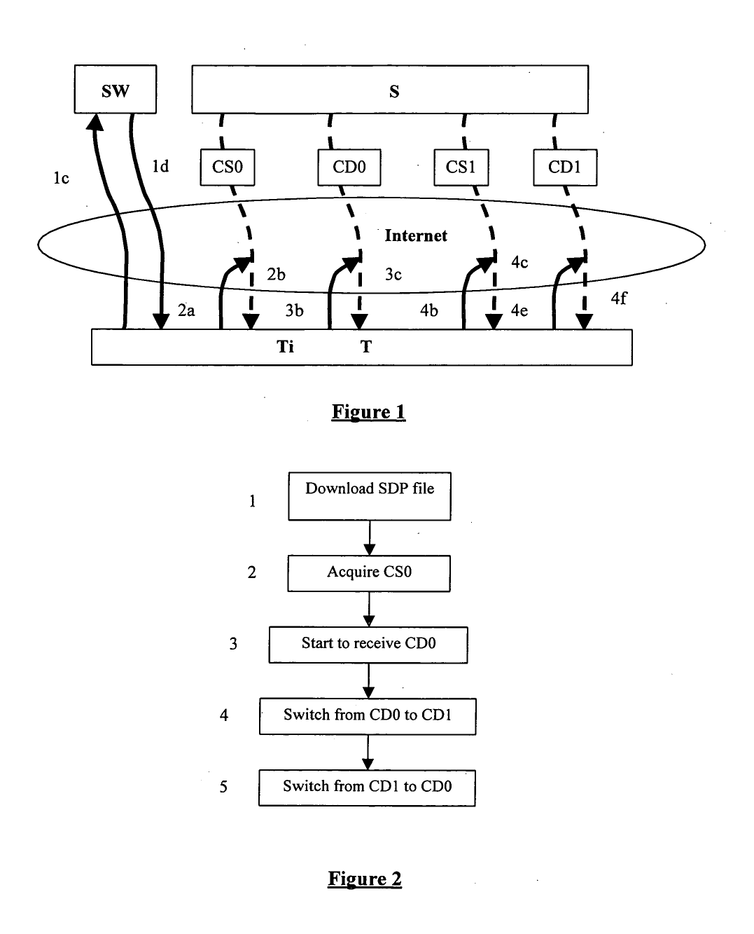

FIG. 1 is a diagram showing a source, with broadcast and signaling channels, a website, the Internet, a receiver terminal, and various steps of this implementation of a method of the invention;

FIG. 2 is a flowchart of the main steps of the FIG. 1 method; and

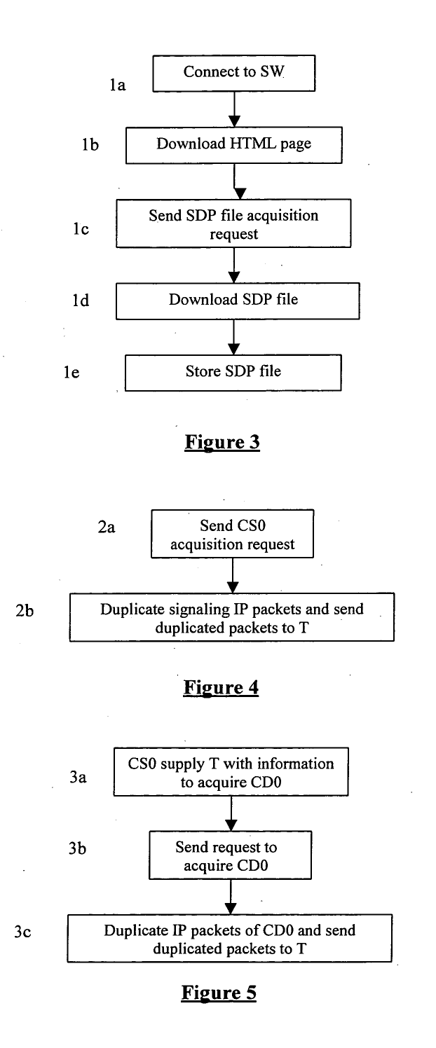

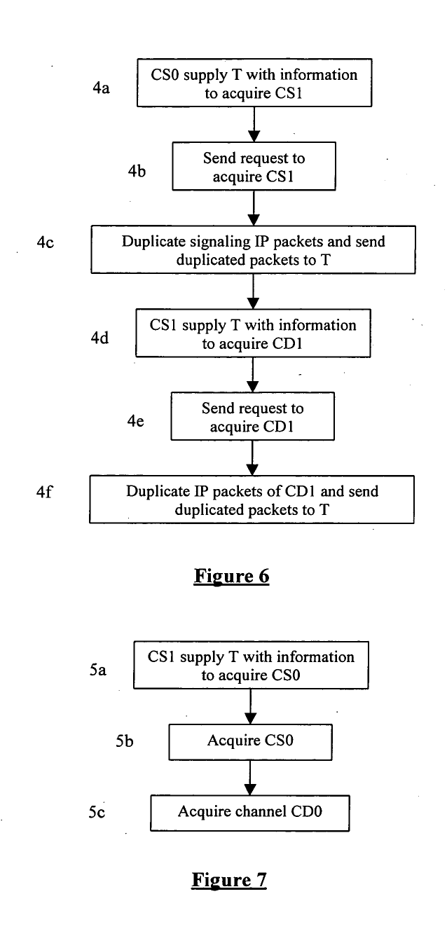

FIGS. 3 to 7 are flowcharts of substeps of the FIG. 2 method.

FIG. 1 shows a broadcast source S, a receiver terminal T, a website SW and the Internet.

In the particular example described here, the source S is a national television station called “TV1” hosted by an audiovisual Internet server and adapted to broadcast content in the form of audiovisual programs (television broadcasts, video films, etc.) to receiver terminals via the Internet in multicast mode, nationally and regionally. The audiovisual server could host other broadcast sources. The multicast mode of broadcasting consists in sending IP data packets carrying the content to be broadcast from the source S in one sending. The IP data packets are then duplicated by a cascade of Internet routers and routed to the receiver terminals via the Internet. The source S has a main channel CD0 for broadcasting national programs and a plurality of secondary channels CD1, CD2, . . . , CDi, . . . , CDn for broadcasting regional programs. A signaling channel CSi is associated with each broadcast channel CDi and is adapted to carry information needed for a terminal to start receiving the broadcast channel CDi.

A programming center, not shown, draws up a schedule of programs broadcast from the source S and creates SDP files relating to the signaling channels CSi associated with the broadcast channels CDi of the source S.

The IETF defines the structure of an SDP file as follows:
v=(protocol version)
o=(owner/creator and session identifier)
s=(session name)
i=* (session information)
u=*(URI of description)
e=*(email address)
p=*(phone number)
c=*(connection information—not required if included in all media)
b=*(bandwidth information)
One or more time descriptions (see below)
z=*(time zone adjustments)
k=*(encryption key)
a=*(zero or more session attribute lines)
Zero or more media descriptions (see below)

Time Description
t=(time the session is active)
r=*(zero or more repeat lines)

Media Description
m=*(media name and transport address)
i=*(media title)
c=*(connection information—optional if included at session level)
b=*(bandwidth information)
k=*(encryption key)
a=*(zero or more attribute lines)

The fields marked “*” are optional. For more information on the structure of SDP data, see the IETF document RFC 2327.

The SDP file relating to a given signaling channel CSi contains a new information field m indicating that the channel described by the SDP file is a signaling channel, “m” signifying “media”, and all the information required for a terminal to acquire the signaling channel CSi. For example, the SDP file relating to the signaling channel CS0 associated with the main broadcast channel CD0 has the following structure:
v=0
s=National station TV1
c=IN IP4 224.2.17.12/127
m=application 49170 RTP/AVP sig

The field c indicates that the signaling channel is broadcast at the multicast Internet address IP4 224.2.17.12. The field m indicates that the channel described is a signaling channel (“sig”), that the signaling channel uses the RTP, and that the number of the port sending signaling data carried by the signaling channel is 49170.

The descriptive SDP fields associated with the source S are stored on the website SW, from which they can be downloaded by the receiver terminals.

The receiver terminals have a web browser enabling them to browse the Internet and an application for receiving broadcast channels that allows each terminal to acquire a signaling channel associated with a broadcast channel and to switch from a first broadcast channel to a second broadcast channel by acquiring a first signaling channel (CS0) associated with the first broadcast channel (CD0) and then, from the first signaling channel (CS0), a second signaling channel (CS1) associated with the second broadcast channel (CD1), and finally to return to receiving the second broadcast channel (CD1), from the first signaling channel (CS0), as explained later.

The reception method of the invention is described below.

The source S sends IP data packets carrying audiovisual content in multicast mode on the main channel CD0 and the secondary channels CD1, . . . , CDi, . . . , CDn, together with IP signaling data packets on associated signaling channels CS0, CS1, . . . , CSi, . . . , CSn.

In a step 1, the receiver terminal T recovers an SDP file associated with the source S, in this instance the SDP file relating to the signaling channel CS0 associated with the main broadcast channel CD0 of the source S. To this end, in a step 1a, the terminal T connects to the website SW and, in a step 1b, downloads from that site an HTML page containing links to the broadcast channels CDi of the source S and to contents broadcast by the source S. In a step 1c, the receiver terminal T selects the link to the broadcast channel CD0 and then sends the website a request to acquire the SDP file relating to the signaling channel CS0 associated with the broadcast channel CD0. On receiving the request, in a step 1d, the site SW transmits the required SDP file to the terminal T via the Internet. In a step 1e, the terminal T stores the downloaded SDP file and therefore has access to it to enable it to receive the signaling channel CS0, either immediately after downloading the SDP file or later.

In a step 2, to receive the main broadcast channel CD0 of the source S, the terminal T first acquires the signaling channel CS0. To this end, in a step 2a, it sends a request to acquire the signaling channel CS0 via the Internet, using the Internet Group Management Protocol (IGMP) and information contained in the SDP file relating to the signaling channel CS0. The first Internet router that receives the request when it is already receiving signaling IP data packets broadcast by the signaling channel CS0 duplicates the IP packets and sends the duplicated packets to the terminal T in a step 2b. The signaling IP packets are routed via the Internet to the terminal T, which therefore starts to receive the signaling channel CS0 associated with the main broadcast channel CD0.

Each signaling channel CSi associated with a broadcast channel CDi conveys the identifier and the type (main or secondary) of the broadcast channel CDi. For example, the signaling channel CS0 associated with the main broadcast channel CD0 of the national station TV1 carries the identifier “National station TV1” and indicates that the broadcast channel CD0 is a main channel. The signaling channel CS1 associated with the channel CD1 broadcasting programs for a region A carries the identifier “TV1 regional station A” and indicates that the broadcast channel CD1 is a secondary channel. Furthermore, each signaling channel CSi carries information needed to receive the associated broadcast channel CDi, namely the multicast Internet address of the broadcast channel CDi, the transmission protocol used by the broadcast channel CDi (which is the RTP in this example), and the types of data broadcast (audio, video, etc.), with the numbers of the ports used to send the data.

In addition to the information relating to the main broadcast channel CD0, the signaling channel CS0 carries information needed to acquire the signaling channel CSi associated with each secondary broadcast channel CDi, namely, for each signaling channel CSi:
the identifier of the associated secondary broadcast channel CDi (TV1 regional station A);
the indication of the broadcast computer network (IN=Internet);
the computer address of the signaling channel CSi (IP4 224.2.17.13);
an indication whether the main channel CD0 and the secondary channel CDi are broadcast simultaneously (sim=1) or alternately (sim=0); and
where applicable, an indication of the time the channel CDi starts broadcasting (t_start=2873397496) and an indication of the time the channel CDi stops broadcasting (t_stop=2873404696).

The information in parentheses is provided by way of illustrative example and relates to the signaling channel CS1 associated with the channel CD1 broadcasting programs to region A.

The signaling channel CSi associated with each secondary broadcast channel CDi contains, in addition to the information relating to the broadcast channel CDi, information needed to acquire the signaling channel CS0 associated with the main broadcast channel CD0, namely the identifier of the main channel CD0 (National station TV1), the indication of the broadcast computer network (In=Internet), the computer address of the associated signaling channel CS0 (IP4 224.2.17.12), and where applicable an indication of the time the second channel CDi stops broadcasting (for example t_stop=2873404696).

In a step 3, using the signaling channel CS0, the terminal T begins to receive the main broadcast channel CD0. To this end, in a step 3a, the signaling channel CS0 supplies the terminal T with the information required to receive the broadcast channel CD0. Using that information, in a step 3b, it sends a request to acquire the main broadcast channel CD0 over the Internet using the IGMP and information contained in the signaling channel CS0. In a step 3c, the first Internet router that receives the request when it is already receiving IP data packets conveying the content broadcast by the main channel CD0 duplicates the IP data packets and sends the duplicated packets to the terminal T. The IP packets are routed to the terminal T via the Internet. Thus the terminal T starts to receive the broadcast channel CD0 and receives the content broadcast over the channel CD0.

In a step 4, the terminal switches from the main broadcast channel CD0 to the secondary broadcast channel CD1. To this end, in a step 4a, the signaling channel CS0 supplies the terminal T with the information required to acquire the signaling channel CS1 associated with the secondary broadcast channel CD1. Using that information, in a step 4b, the terminal T sends a request to acquire the signaling channel CS1 associated with the secondary broadcast channel CD1 over the Internet using the IGMP. In a step 4c, the first Internet router that receives the request when it is also receiving the signaling IP data packets broadcast over the channel CS1 duplicates the signaling IP packets and sends them to the terminal T. The signaling IP packets are routed via the Internet to the terminal T. Thus the terminal T starts to receive the signaling channel CS1. In a step 4d, the signaling channel CS1 supplies the terminal T with all the information it needs to start receiving the associated broadcast channel CD1. In a step 4e, using that information, the terminal T sends a request to acquire the associated secondary broadcast channel CD1 over the Internet using the IGMP. In a step 4f, the first Internet router that receives the request when it is already receiving IP data packets conveying the content broadcast by the secondary channel CD1 duplicates the IP data packets and sends the duplicated packets to the terminal T. The IP packets are routed via the Internet to the terminal T, which starts to receive the secondary broadcast channel CD1 and receives the content broadcast by the channel CD1.

In a step 5, the terminal T switches from the secondary channel CD1 to the main channel CD0. To this end, in a step 5a, the signaling channel CS1 associated with the broadcast channel CD1 it is receiving supplies the terminal T with the information needed to acquire the channel CS0, namely the identifier of the main channel CD0 and the Internet address of the signaling channel CS0 associated with the main channel CD0. Using that information, in a step 5b, the terminal T acquires the signaling channel CS0 and then, in a step 5c, from the signaling channel CS0, it acquires the main broadcast channel CD0, as previously described for steps 3a-c.

When the terminal T is receiving the main broadcast channel CD0, the associated signaling channel CS0, where applicable, informs it of the starting and stopping of parallel (i.e. simultaneous) broadcasting via the secondary channels CDi. Using this information, as soon as a secondary channel is broadcasting a content when the main channel is already broadcasting a content, the terminal T displays an icon to inform the user of parallel broadcasting via the secondary channel. The user can then select the icon and thereby activate a command to switch to the secondary channel. The terminal T then executes above-described step 4.

When the terminal is receiving the content broadcast by a broadcast channel CDi, the associated signaling channel CSi indicates when the current broadcast stops. Using this information, when broadcasting stops on the channel it is receiving, the terminal could automatically switch to another broadcast channel CDi, whether the latter is a default channel or a channel previously programmed by the user. For example, when broadcasting on a secondary channel stops, the terminal could switch automatically to the main channel. It is also possible to envisage enabling the user to program an automatic broadcast channel change at a given time, at the end of the broadcasting of a specific content, or when a particular secondary broadcast channel starts up.

It should be emphasized here that the signaling channel CS0 associated with the main broadcast channel conveys the information necessary for acquiring the signaling channels associated with all the secondary broadcast channels CDi. However, the signaling channel associated with each secondary broadcast channel CDi carries only the information needed to acquire the signaling channel CS0 associated with the main broadcast channel CD0, to the exclusion of information needed to acquire the signaling channels associated with other secondary broadcast channels. Accordingly, the terminal must switch from one secondary broadcast channel to another secondary broadcast channel via the signaling channel associated with the main broadcast channel. This limits the quantity of information conveyed via the signaling channels associated with the secondary broadcast channels and limits the problem of dynamically updating those channels.

In the description above, the broadcast channels of the source S form a hierarchical group in which all secondary channels are linked to the main channel.

As a general rule, the contents are broadcast by a plurality of broadcast channels associated with a plurality of respective signaling channels and forming a group of channels. Each signaling channel associated with a broadcast channel supplies the terminal T with the information needed to acquire one or more other signaling channels associated with another broadcast channel of the same group, so that the terminal T can access all the broadcast channels of the group. For example, a group of broadcast channels organized into a hierarchy different from that described could be envisaged, for instance with a secondary channel being the main channel of a plurality of channels, or a group of non-hierarchical broadcast channels (for example to broadcast pictures from a plurality of cameras filming the same event from different angles). In which case, the signaling channel associated with each broadcast channel can convey all the information needed to acquire the signaling channels associated with all other broadcast channels.

The server S in FIG. 1 could be replaced by a plurality of servers between which the load of the various channels is spread.

The invention could be applied to a computer network other than the Internet.

1. A method of reception, by a terminal (T), of content broadcast over a computer network by a plurality of broadcast channels (CD0, CD1, . . . ) forming a group of channels linked in accordance with a given organization, in which method:
each broadcast channel (CD0, CD1, . . . ) is associated with a signaling channel (CS0, CS1, . . . ) conveying information for acquiring said broadcast channel (CD0, CD1, . . . ),
the terminal (T) acquires a first signaling channel (CS0) associated with a first broadcast channel (CD0) and, from said first signaling channel (CS0), starts to receive the first broadcast channel (CD0), and
to switch from the first broadcast channel (CD0) to a second broadcast channel (CD1) linked to the first broadcast channel (CD0), the terminal T acquires a second signaling channel (CS1) associated with a second broadcast channel (CD 1) from the first signaling channel (CS0) and, from the second signaling channel (CS1), starts to receive the second broadcast channel (CD1).

2. A method according to claim 1, wherein, to switch from the second broadcast channel (CD1) to the first broadcast channel (CD0), the terminal (T) acquires the signaling channel (CS0) associated with the first broadcast channel (CD0) from the signaling channel (CS1) associated with the second broadcast channel (CD1).

3. A method according to claim 1, wherein the signal channel (CS0, CS1) associated with one of the broadcast channels (CD0, CD1) indicates to the terminal (T) whether the two broadcast channels (CD0, CD1) are broadcasting simultaneously or alternately.

4. A method according to claim 1, wherein the signaling channel (CS0, CS1) associated with one of the broadcast channels (CD0, CD1) supplies the terminal (T) with a computer address of the signaling channel (CS1, CS0) associated with the other broadcast channel (CD1, CD0).

5. A method according to claim 1, wherein the signaling channel (CS0, CS1) associated with one of the broadcast channels (CD0, CD1) supplies the terminal (T) with an indication of the starting of broadcasting via the other broadcast channel (CD1, CD0).

6. A method according to claim 1, wherein the signaling channel (CS0, CS1) associated with one of the broadcast channels (CD0, CD1) supplies the terminal with an indication of the stopping of broadcasting via the other broadcast channel (CD1, CD0).

7. A method according to claim 6, wherein the terminal (T) uses the indication of stopping of broadcasting to change broadcast channel (CD1, CD0) automatically when broadcasting stops.

8. A method according to claim 1, wherein, during reception of the content broadcast by one of the broadcast channels (CD0, CD1), the terminal (T) signals to a user concomitant broadcasting via the other broadcast channel (CD1, CD0) and changes broadcast channel in response to a switching command from said user.

9. A method according to claim 1, wherein each signaling channel supplies the terminal (T) with information for acquiring one or more other signaling channels associated with another broadcast channel of said group so that the terminal can access all the broadcast channels of the group.

10. A method according to claim 9, wherein the group of channels comprises a main channel (CD0) and a plurality of secondary channels (CD1, . . . , CDi, . . . , CDn) and the signaling channel associated with the main channel (CD0) supplies the terminal (T) with the information to acquire signaling channels (CS1, . . . , CSi, . . . , CSn) associated with all the secondary channels (CD1, . . . , CDi, . . . , CDn).

11. A method according to claim 10, wherein the signaling channel (CS1, . . . , CSi, . . . , CSn) associated with each secondary channel (CD1, . . . , CDi, . . . , CDn) supplies the terminal (T) with information for acquiring the signaling channel (CS0) associated with the main channel (CD0), to the exclusion of information for the signaling channels (CS1, . . . , CSi, . . . , CSn) associated with the other secondary channels (CD1, . . . , CDi, . . . , CDn).

12. A method according to claim 10, wherein the signaling channel (CS1, . . . , CSi, . . . , CSn) associated with each secondary channel (CD1, . . . , CDi, . . . , CDn) supplies the terminal (T) with information for acquiring the signaling channel (CS0) associated with the main channel (CD0) and information for acquiring another signaling channel (CS1, . . . , CSi, . . . , CSn) associated with another broadcast channel (CD1, . . . , CDi, . . . , CDn) of the same group.

13. A terminal for implementing the method according to claim 1, comprising means for acquiring a signaling channel associated with a broadcast channel and means for switching from a first broadcast channel to a second broadcast channel adapted to acquire a first signaling channel (CS0) associated with the first broadcast channel (CD0) and then, from said first signaling channel (CS0), a second signaling channel (CS1) associated with the second broadcast channel (CD1), and finally to start to receive the second broadcast channel (CD1) from the first signaling channel (CS0).
